(19) United States
(12) Patent Application Publication
(10) Pub. No.: US 2024/0126744 A1
(43) Pub. Date: Apr. 18, 2024

(54) TRANSACTION-AWARE TABLE PLACEMENT

(71) Applicant: VMware, Inc., Palo Alto, CA (US)

(72) Inventors: Abhishek GUPTA, San Jose, CA (US); Christos KARAMANOLIS, Los Gatos, CA (US); Richard P. SPILLANE, Mountain View, CA (US); Martin DEKOV, Sofia (BG); Ivo STRATEV, Sofia (BG)

(21) Appl. No.: 17/967,286

(22) Filed: Oct. 17, 2022

(51) Int. Cl. G06F 16/23; G06F 16/22

(52) U.S. Cl. CPC G06F 16/2379; G06F 16/2282

(57) ABSTRACT

Intelligent, transaction-aware table placement minimizes cross-host transactions while supporting full transactional semantics and delivering high throughput at low resource utilization. This placement reducing delays caused by cross-host transaction coordination. Examples determine a count of historical interactions between tables, based on at least a transaction history for a plurality of cross-table transactions. Each table provides an abstraction for data, such as by identifying data objects stored in a data lake. For tables on different hosts, having high count of historical interactions, potential cost savings achievable by moving operational control of a first table to the same host as the second table is compared with the potential cost savings achievable by moving operational control of the second table to the same host as the first table. Based on comparing the relative cost savings, one of the tables may be selected. Operational control of the selected table is moved without moving any of the data objects.

### BACKGROUND

Petabyte-scale data analytics platforms are built on two principles: a) scale-out cloud storage (e.g., S3) with wide bandwidth, in which each data object is globally identifiable and accessible; b) separate scale-out compute infrastructure in which data processing is distributed across multiple nodes to achieve scale. Implementing consistency, or any other transactional property, in such environments requires tight coordination across many compute nodes (hosts) and may quickly become a scale and performance bottleneck.

In common data lakes, data is stored as files or objects, often in open formats, such as Parquet and ORC, and may be accessed through quasi-standard protocols, such as S3 and Hadoop Distributed File System (HDFS). Open-source query engines, including Presto/Trino and SparkSQL are used on top of file/object protocols to offer a SQL interface to the data, much like traditional data warehouses. However, unlike data warehouses, metadata management may use open formats (e.g., Hive and Spark RDD) that integrate with open-source compute platforms.

Open data warehouses lack the transactional semantics of traditional databases and data warehouses. In general, this increases the complexity of applications built on them. For example, data engineers need to ensure that SQL queries read consistent data across tables—even as new data is being ingested by writing directly into underlying files. Similarly, developers need to implement isolation and atomicity across read/write transactions to data lake tables. Thus, solutions are emerging that provide transactional properties on data lakes.

Implementing transactions on the scale-out architectures of modern data platforms requires distributed protocols, such as 2-phase commit (2PC), for coordination between multiple compute nodes. Unfortunately, such cross-host coordination becomes a scale and performance bottleneck and defeats the purpose of a scale-out platform. Some existing solutions implement workarounds which, however, limit the applicability of the transactional model supported. For example, some solutions support only single-table transactions, requiring that all operations of a transaction are serialized through a single host, and some traditional databases and data warehouses limit the size of compute clusters.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Aspects of the disclosure provide solutions for intelligent transaction-aware table placement. Example operations include: based on at least a transaction history for a plurality of cross-table transactions, determining, for a plurality of tables, a count of historical interactions between tables of the plurality of tables; determining a first cost savings of moving operational control of a first table from a first host to a second host, wherein the first table identifies a first data object; determining a second cost savings of moving operational control of a second table from the second host to the first host, wherein the second table identifies a second data object; and based on at least the first cost savings and the second cost savings, moving operation control of the first table from the first host to the second host, without moving the first data object and without moving the second data object.

### BRIEF DESCRIPTION OF THE DRAWINGS

The present description will be better understood from the following detailed description read in the light of the accompanying drawings, wherein:

FIG. 1 illustrates an example architecture that advantageously provides abstracted access to a large scale (e.g., multi-host or multi-node) data lake with an overlay file system, and which may benefit from transaction-aware table placement;

FIGS. 2A and 2B illustrate examples of a tree data structure and a master branch with multiple point-in-time snapshots of its state, as may be used by the architecture of FIG. 1, with FIG. 2A showing detail and FIG. 2B showing various points in time;

FIG. 3A illustrates an example data partitioning structure, as may be used by the architecture of FIG. 1;

FIG. 3B illustrates examples of data, as may be used by the architecture of FIG. 1, and which may be operated upon by transaction-aware table placement;

FIG. 4 illustrates an example architecture that advantageously provides transaction-aware table placement, and is built on top of an architecture such as the example of FIG. 1;

FIG. 5 illustrates an example workflow, as may be implemented when using examples of the disclosure such as the architecture of FIG. 4;

FIG. 6 illustrates an example weighted graph, as may be used by examples of the disclosure such as the architecture of FIG. 4;

FIG. 7 illustrates a flowchart of exemplary operations associated with examples of the disclosure such as the architecture of FIG. 4;

FIG. 8 illustrates another flowchart of exemplary operations associated with examples of the disclosure such as the architecture of FIG. 1; and

FIG. 9 illustrates a block diagram of a computing apparatus that may be used as a component of examples of the disclosure such as the architecture of FIG. 1 and/or FIG. 4.

Any of the above figures may be combined into a single example or embodiment.

### DETAILED DESCRIPTION

Intelligent transaction-aware table placement minimizes cross-host transactions, thereby reducing delays caused by cross-host transaction coordination (e.g., two-phase commit operations). A table represents a set of data that may be organized in different formats including, for example, column-based or row-based optimized formats. The data of a table may reside in one or more data objects (e.g., files, objects, volumes) stored on a data lake. The mapping of tables to data objects as well as some of the information about columns, rows or other table metadata may be stored in a metadata service (e.g., a dedicated file, a database like Hive, etc.). As used herein, table placement refers to the assignment, to a particular host, of the ownership of a table so that the host is able to perform operations on the table. This capability is reserved for a single host at any given time (e.g., one host at any point in time for a particular table). Table placement may also be referred to as table ownership, table control, and the like. Moving operational control of a table changes the host that performs the operations to the table, or has ownership of the table. The actual location of the data may not change when operational control of a table is moved. Examples of the disclosure separate compute and storage capability, so that each is able to scale independently. Example storage solutions permit access to data belonging to any table from any compute host.

Examples determine a count of historical interactions between a plurality of tables, based on at least a transaction history for a plurality of cross-table transactions. Each table provides an abstraction for data, such as by identifying (listing, indicating or referring to) data objects (e.g., files) stored in a data lake. For tables on different hosts having high count of historical interactions, potential cost savings achievable by moving operational control of a first table to the same host as a second table is compared with the potential cost savings achievable by moving operational control of the second table to the same host as the first table. Based on the relative cost savings, one of the tables may be selected, while operational control of the other table remains. Notably, operational control of the selected table is moved without moving any of the underlying data objects.

Aspects of the disclosure introduce a partitioning approach that distributes the execution of transactions across large and even dynamically changing, compute clusters in open data warehouses. This approach may support full transactional semantic, while delivering high throughput at low resource utilization. In open data warehouses, access to a table may be serialized through a single host or compute node, in which a single host typically serves multiple tables. In such environments, software such as query engines (e.g., Trino), analytics runtime environments (e.g., Spark), and data pipeline platforms (e.g., Fling) execute on compute hosts and access data in a data lake. Each host may access any data in the data lake, and any table stored in the data lake. However, access to a specific table may be serialized through a single host to ensure consistent and correct access to that table. That is, only one host may perform operations on any table at a point in time. In addition, transactions typically involve read and write operations to a multitude of tables. To implement the desirable transactional semantics (e.g., atomicity, consistency, isolation, and durability, or ACID), a transaction that involves multiple tables that are controlled by multiple hosts, may require coordination between those hosts (e.g., using 2-phase commit, or 2PC).

The set of tables that transactions involve may allow a table-to-host mapping that minimizes cross-host coordination, because a typical transaction may reference only a small subset of the tables, even in a large data warehouse. Each transaction is able to access a subset of tables in one table group (or data group or schema). In some scenarios, multiple transactions may consistently access the same table group. The knowledge of table groups assists with determining efficient optimization heuristics. In a simple case, a small table group may be handled by a single host, thus eliminating any need for cross-host coordination for the transactions accessing that table group.

Co-locating tables in a table group that are accessed together, onto a single host, minimizes cross-host coordination, thereby increasing the aggregate throughput of open data warehouses. These technical advantages are available even with evolving table groups, transactions, and cluster sizes, and may require no changes to existing data lakes and metadata services.

Aspects of the disclosure improve the functioning of computing devices at least by reducing the computing power required for operating data lakes. For example, both the workload and number of nodes required by a compute tier of a data lake is reduced, at least in part, by determining cost savings of moving operational control of tables from a first host to a second host and, based on at least the cost savings, moving operational control of a table from the first host to the second host without moving the identified data objects of the table.

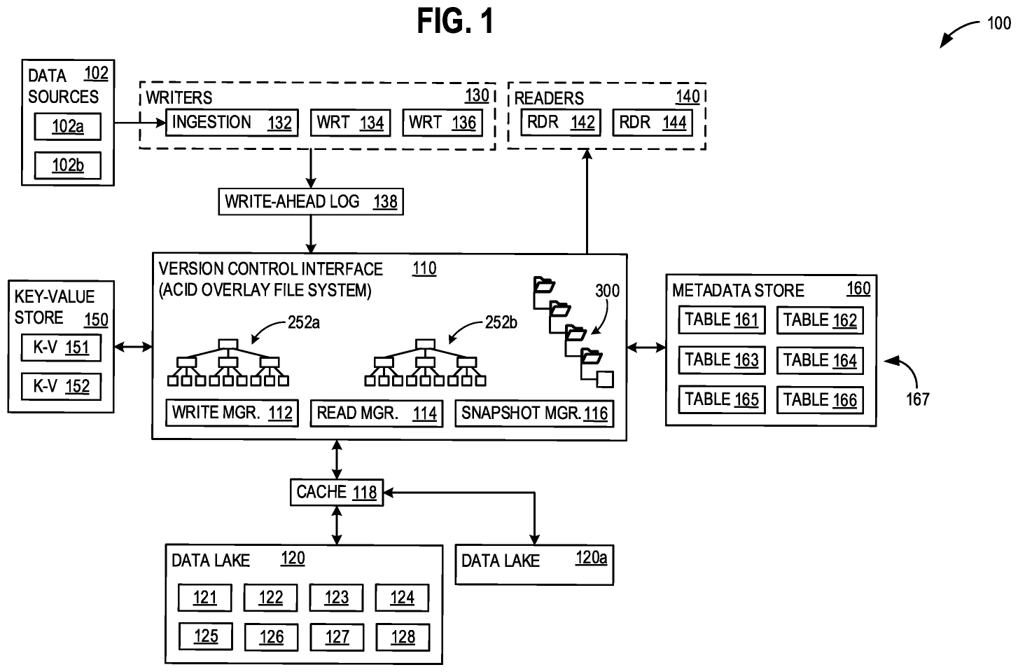

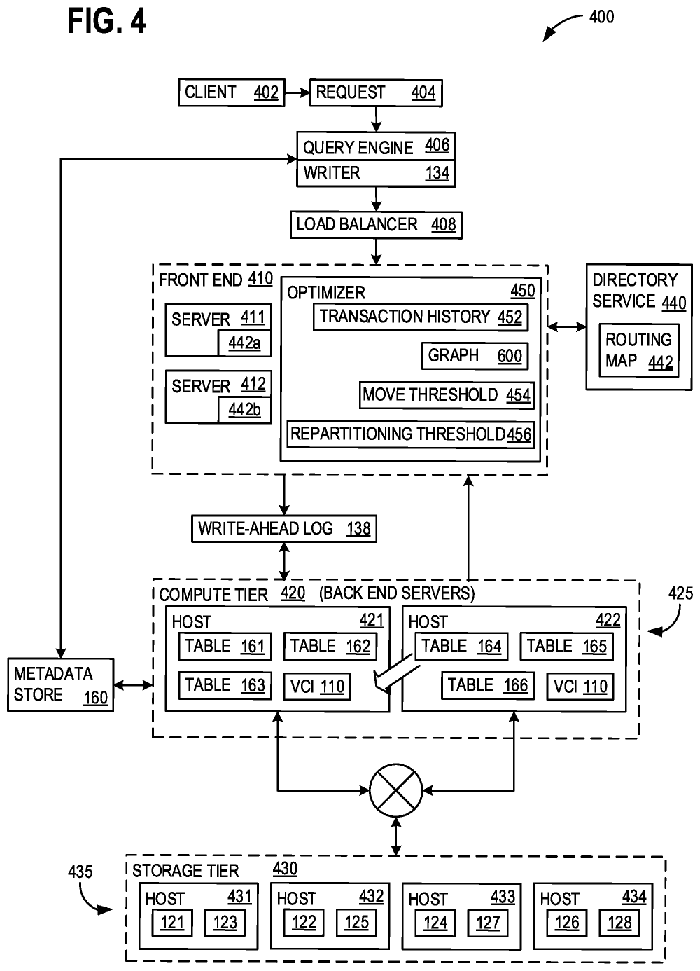

FIG. 1 illustrates an architecture 100 that advantageously improves access to a data lake 120 and with an overlay file system, identified as a version control interface 110. As indicated, version control interface 110 is able to access multiple data lakes, including a data lake 120a. As described herein, architecture 100 may benefit from transaction-aware table placement disclosed herein and may be implemented in conjunction with an architecture 400 of FIG. 4.

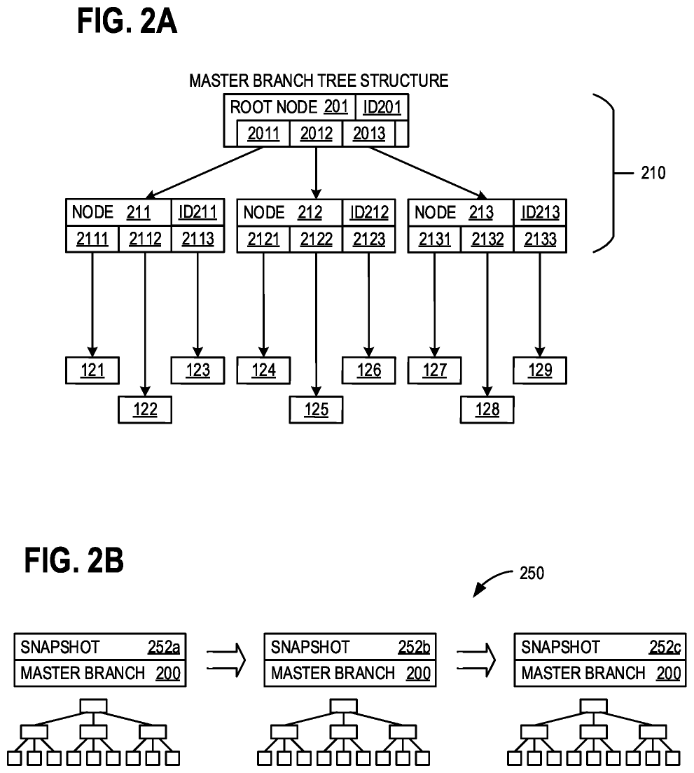

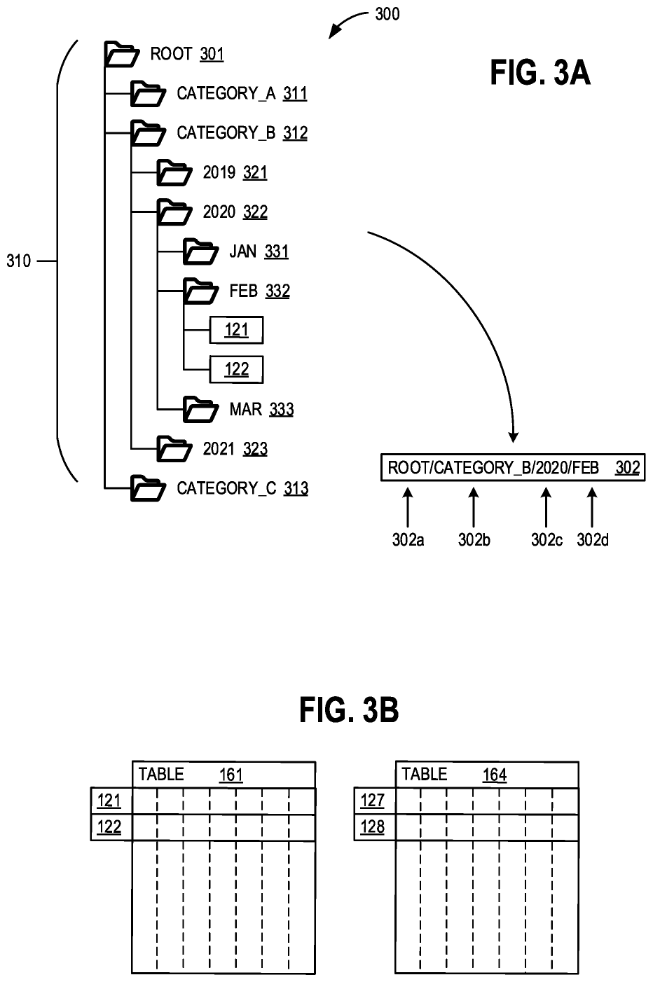

In some examples, version control interface 110 overlays multiple data stores, providing data federation (e.g., a process that allows multiple data stores to function as a single data lake). A write manager 112 and a read manager 114 provide a set of application programming interfaces (APIs) for coordinating access by a plurality of writers 130 and a plurality of readers 140. Writers 130 and readers 140 include, for example, processes that write and read, respectively, data to/from data lake 120. Version control interface 110 leverages a key-value store 150 and a metadata store 160 for managing access to the master branch, as described in further detail herein. A master branch 200 is illustrated and described in further detail in relation to FIGS. 2A and 2B. FIG. 2A shows the tree structure and FIG. 2B shows snapshots in various points in time. A notional data partitioning structure 300, representing the hierarchical namespace of the overlay file system, is illustrated and described in further detail in relation to FIG. 3A.

A master branch (main branch, public branch) is a long-lived branch (e.g., existing for years, or indefinitely) that can be used for both reads and writes. It is the default branch for readers unless the readers are being used to read in the context of a transaction. The master branch includes a set (e.g., list) of snapshots, each of which obey conflict resolution policies in place at the time the snapshot was taken. The snapshots may be organized in order of creation. The term “master branch” is a relational designation indicating that other branches (e.g., private branches and workspace branches) are copied from it and merged back into it.

A workspace branch is forked off the master branch for writing and/or reading, and then either merged back into the master branch or aborted. Reading occurs in the context of a transaction. In some examples, a workspace branch represents a single SQL transaction. In some examples, there is a one-to-one relationship between a workspace and a transaction, and the lifecycle of a workspace branch is the same as that of its corresponding transaction.

A private branch is a fork from the master branch used to facilitate write operations in an isolated manner, before being merged back into the master branch. A private branch may also act as a write buffer for streaming data. Private branches are used for data ingestion, such as streaming incoming data or asynchronous transactions. In transactional data ingestion, clients send batches of data to be inserted for possibly multiple tables within one data group. The incoming data may span one or more data messages. Each batch of data serves as a boundary for an asynchronous transaction. Private branches improve the concurrency of the system and may exist for the duration of the execution of some client-driven workflow, e.g., a number of operations or transactions, until being merged back into the master branch. They may be used as write buffers (e.g., for write-intensive operations such as ingesting data streaming), and reading is not permitted. Multiple writers and multiple streams may use the same private branch.

In some examples, a merge process iterates through new files, changed files, and deleted files in the private or workspace branch, relative to what had been in master branch when the merging private branch had been forked, to identify changes. The merging process also identifies changes made to the master branch (e.g., comparing the current master branch with the version of the master branch at the time of forking) concurrently with changes happening in a private branch or a workspace branch. For all of the identified changes, the files (more generally, data objects) are compared to the files at the same paths in the master branch to determine if a conflict exists. If there is a conflict, a conflict resolution solution is implemented. Aspects of the disclosure are operable with multiple conflict resolution policies.

To enable concurrent readers and writers, snapshots are used to create branches. Some examples use three types of branches: a master branch (only one exists at a time) that is used for reading both data and metadata at a consistent point in time, a private branch (multiple may exist concurrently) that acts as a write buffer for synchronous transactions and excludes other readers, and a workspace branch (multiple may exist concurrently) that facilitates reads and writes for certain transactions, such as SQL transactions. Private branches and workspace branches may be forked from any version of a master branch, not just the most recent one. In some examples, even prior versions of a master branch snapshot may be written to.

In some examples, the master branch is updated atomically only by merging committed transactions from the other two types of branches. Readers use either the master branch to read committed data or a workspace branch to read in the context of an ongoing transaction. Writers use either a private branch or a workspace branch to write, depending on the type of workload, ingestion, or transactions respectively. Private and workspace branches may be instantiated as snapshots of the master branch by copying the root node of the tree (e.g., the base). In some examples, writers use copy-on-write (CoW) to keep the base immutable for read operations (private branches) and for merging. CoW is a technique to efficiently create a copy of a data structure without time consuming and expensive operations at the moment of creating the copy. If a unit of data is copied but not modified, the “copy” may exist merely as a reference to the original data, and only when the copied data is modified is a physical copy created so that new bytes may be written to memory or storage.

To write to the data lake, whether in bulk (e.g., ingest streams of large number of rows) or individual operation (e.g., a single row or a few rows), a writer checks out a private branch and may independently create or write data objects in that branch. That data does not become visible to other clients (e.g., other writers and readers). At a fixed interval or when enough data is accumulated, the completed transactions are committed. This creates space for new messages. Private branches are merged in order to meet data read latency requirements (e.g., in service level agreement, or SLA), to ensure solid performance by leveraging buffering, and to reduce replay time in the event of a recovery or restart).

Even after a commit, the new data remain visible only in the writer's private branch. Other readers have access only to a public master branch (the writer can also read from the writer's own private branch). To ensure correctness, a merging process occurs from the private branches to the master branch thus allowing the new data to become publicly visible in the master branch. This enables a consistent and ordered history of writes. In this manner, branching and snapshots provide for ACID.

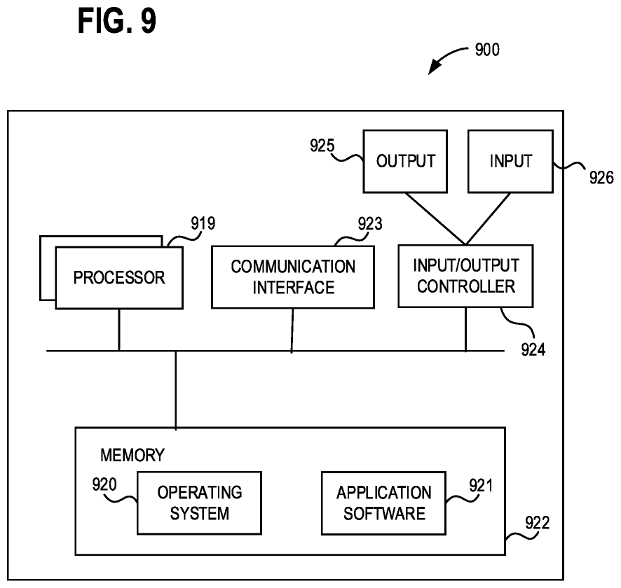

In some examples, architecture 100 is implemented using a virtualization architecture, which may be implemented on one or more computing apparatus 900 of FIG. 9. An example computing framework on which the components of FIG. 1 may be implemented and executed uses a combination of virtual machines, containers, and serverless computing abstractions. Example storage on which the data lake may be implemented is a cloud storage service, or a hardware/software system. The storage can be a file system or an object storage system.

Some examples of version control interface 110 support common query engines, while also enabling efficient batch and streaming analytics workloads. Federation of multiple heterogeneous storage systems may be supported, and data and metadata paths may be scaled independently and dynamically, according to evolving workload demands. ACID semantics may be provided using optimistic concurrency control, which also provides versioning, and lineage tracking for data governance functions. This facilitates tracing the lifecycle of the data from source through modification (e.g., who performed the modification, and when). In some examples, a host is defined as a computing resource unit for purposes of ACID. That is a single physical machine may crash, stopping all running processes on that machine, while a nearby separate physical machine continues running. Thus, cross-host coordination is needed at least for durability.

Data lake 120 holds multiple data objects, illustrated at data objects 121-128. Data lake 120 also ingests data from data sources 102, which may be streaming data sources, via an ingestion process 132 that formats incoming data as necessary for storage in data lake 120. Data sources 102 is illustrated as comprising a data source 102a and a data source 102b. Data objects 121-128 may be structured data (e.g., database records), semi-structured (e.g., logs and telemetry), or unstructured (e.g., pictures and videos).

Inputs and outputs are handled in a manner that ensures speed and reliability. Writers 130, including ingestion process 132, writer 134, and writer 136, leverage a write ahead log (WAL) 138 for crash resistance which, in combination with the persistence properties of the data lake storage, assists with the durability aspects of ACID. WAL 138 is a separate service in which write operations are persisted in their original order of arrival and is used to ensure transactions are implemented even in the presence of failures. In some examples, WAL 138 is check-pointed with the update of the most-recent snapshot hash in order to reduce the replay time in case of a recovery (e.g., avoid replaying everything since inception of the branch). The values for the branch keys in key-value store 150 contain the offset of a commit operation taken out of WAL 138.

For example, in the event of a crash (e.g., software or hardware failure), crash recovery functionality may replay WAL 138 to reconstruct messages or re-apply state changes in order to recover the state prior to the crash. WAL 138 provides redo information that assists with atomicity. In some examples, WAL 138 is implemented using Kafka.

In some examples, version control interface 110 uses a cache 118 to interface with data lake 120 (or multiple data lakes 120, when version control interface 110 is providing data federation) to improve operations, for example operational speed. Write manager 112 manages writing objects (e.g., files) to data lake 120. Although write manager 112 is illustrated as a single component, it may be implemented using a set of distributed functionality, similarly to other illustrated components of version control interface 110.

Metadata store 160 organizes data (e.g., data objects 121-128) into a plurality of tables 167, such as a table 161, a table 162, a table 163, a table 164, a table 165, and a table 166. Examples of tables are shown in FIG. 3B. Maps of tables 161-166 may be stored in metadata store 160 and/or on servers (see FIG. 4) hosting an implementation of version control interface 110. A table provides a hierarchical namespace, typically organized by a default partitioning policy of some of the referenced data attributes, e.g., the date (year/month/day) of the data creation, as indicated for data partitioning structure 300 in FIG. 3A. For example, a partition holds data objects created in a specific day. If one of readers 140, illustrated as including a reader 142 and a reader 144, performs a query using a structured query language (SQL) statement that performs a SELECT operation over a range of dates, then the organization of data partitioning structure 300 indicates the appropriate directories and data objects in the overlay file system to locate the partitions from which to read objects.

Data may be written in data lake 120 in the form of transactions, for ACID purposes. This ensures that all of the writes that are part of a transaction are manifested at the same time (e.g., available for reading by others), so that either all of the data included in the transaction may be read by others (e.g., a completed transaction) or none of the data in the transaction may be read by others (e.g., an aborted transaction). Atomicity guarantees that each transaction is treated as a single unit, which either succeeds completely, or fails completely. Consistency ensures that a transaction can only transition data from one valid state to another. Isolation ensures that concurrent execution of transactions leaves the data in the same state that would have been obtained if the transactions were executed sequentially. Durability ensures that once a transaction has been committed, the results of the transaction (its writes) will persist even in the case of a system failure (e.g., power outage or crash).

Version control interface 110 atomically switches readers to a new master branch (e.g., switches from master branch snapshot 252a to master branch snapshot 252b) after a transaction is committed and the workspace branch (or private branch) is merged back into a master branch. Consistency is maintained during these switching events by moving new readers 140 from the prior master branch to the new master branch at the same time, so that all new readers 140 see the same version of data. In some examples, older readers are not moved, in order to maintain consistency for those readers. To facilitate the move, a key-value store 150 has a key-value entry for each master branch, as well as key-value entries for private and workspace branches. A key-value store is a data storage paradigm designed for storing, retrieving, and managing associative arrays. Data records are stored and retrieved using a key that uniquely identifies the record and is used to find the associated data (values), which may include attributes of data associated with the key.

The key-value entries are used for addressing the root nodes of branches. For example, a key-value pair 151 points to a first version of master branch 200 (or master branch snapshot 252a), and a key-value pair 152 points to a second version of master branch 200 (or master branch snapshot 252b). In some examples, key-value store 150 is a distributed key-value store, such as ETCD.

There is a single instance of a namespace (a master branch) for each group of tables, in order to implement multi-table transactions. In some examples, to achieve global consistency for multi-table transactions, read requests from readers 140 are routed through key-value store 150, which tags them by default with the key-value pair for the most recent master branch snapshot. Because the branching and snapshot process described above provides for ACID properties, it may be leveraged for multi-table transaction consistency. Time travel may be supported by some examples, in which a reader instead reads data objects 121-128 from data lake 120 using a prior master branch snapshot.

A 2PC process (or protocol), which updates key-value store 150, is used to perform atomic execution of writes when a set of tables accessed together, known as a table group, spans multiple hosts (e.g., multiple physical servers) and coordination between the different hosts is needed.

Tables 161-166 may be represented using a tree data structure 210 of FIG. 2A for master branch 200. Turning briefly to FIG. 2A, the structure of master branch 200 comprises a root node 201, which is associated with an identifier ID201, and contains references 2011-2013 to lower nodes 211-213. Tree data structure 210 may be stored in data lake 120 or in a separate storage system. That is, the objects that comprise the overlaid metadata objects do not need to be stored in the same storage system as the data itself. For example, tree data structure 210 may be stored in a relational database or key-value store.

The identifiers, such as identifier ID201 may be any universally unique identifiers (UUIDs). One example of a UUID is a content-based UUID. A content-based UUID has an added benefit of content validation. An example of an overlay data structure that uses content-based UUIDs is a Merkle tree, although any cryptographically unique ID is suitable. The data structures implement architecture 100 (the ACID overlay file system) of FIG. 1. In some examples, the nodes of the data structures are each uniquely identified by a UUID. Any statistically unique identification may be used, if the risk of a collision is sufficiently low. A hash value is an example. In the case where the hash is that of the content of the node, the data structure may be a Merkle tree. However, aspects of the disclosure are operable with any UUID, and are not limited to Merkle trees, hash values, or other content-based UUIDs.

In an overlay file system that uses content-based UUIDs for the data structure nodes (e.g., a Merkle tree), identifier ID201 comprises the hash of root node 201, which contains the references to nodes 211-213. Node 211, which is associated with an identifier ID211, has reference 2111, reference 2112, and reference 2113 (e.g., addresses in data lake 120) to data object 121, data object 122, and data object 123, respectively. In some examples, identifier ID211 comprises a hash value (or other unique identifier) of the content of the node, which includes references 2111-2113. For example, in intermediate nodes, the contents are the references to other nodes. The hash values may also be used for addressing the nodes in persistent storage. Those skilled in the art will note that the identifiers need not be derived from content-based hash values but could be randomly generated. Content-based hash values (or other one-way function values) in the nodes, however, have an advantage in that they may be used for data verification purposes.

Node 212, which is associated with an identifier ID212, has reference 2121, reference 2122, and reference 2123 (e.g., addresses in data lake 120) to data object 124, data object 125, and data object 126, respectively. In some examples, identifier ID212 comprises a hash value of references 2121-2133. Node 213, which is associated with an identifier ID213, has reference 2131, reference 2132, and reference 2133 (e.g., addresses in data lake 120) to data object 127, data object 128, and data object 129, respectively. In some examples, identifier ID213 comprises a hash value of references 2131-2133. In some examples, each node holds a component of the name space path starting from the table name (see FIG. 3). Nodes are uniquely identifiable by their hash value (e.g., identifiers ID211-ID213). In some examples, tree data structure 210 comprises a Merkle tree, which is useful for identifying changed data, and facilitates versioning and time travel. However, aspects of disclosure are operable with other forms of tree data structure 210. Further, the disclosure is not limited to hash-only IDs (e.g., Merkel tree). However, hashes may be stored for verification.

The term “master branch” is a relational designation indicating that other branches (e.g., private branches) are copied from it and merged back into it. In some examples, a merge process iterates through new files, changed files, and deleted files in the private or workspace branch, relative to what had been in master branch when the merging private branch had been forked, to identify changes. The merging process also identifies changes made to the master branch (e.g., comparing the current master branch with the version of the master branch at the time of forking) concurrently with changes happening in a private branch. For all of the identified changes, the files (more generally, data objects) are compared to the files at the same paths in master branch 200 to determine if a conflict exists. If there is a conflict, a conflict resolution solution is implemented. Aspects of the disclosure are operable with multiple conflict resolution policies.

Since master branch 200 may be constantly changing, various versions are captured in snapshots, as shown in FIG. 2B. A snapshot is a set of reference markers for data at a particular point in time. In relation to master branch 200, a snapshot is an immutable copy of the tree structure, whereas a branch (e.g., a private branch) is a mutable copy. A snapshot is uniquely identified by its unique root node for that instance. Each snapshot acts as an immutable point-in-time view of the data. A history of snapshots may be used to provide access to data as of different points in time and may be used to access data as it existed at a certain point in time (e.g., rolled back in time for time travel).

A snapshot manager 116 handles the generation of master branch snapshots 252a and 252b. New master branches are created upon merging data from a private branch. A private branch is merged with the master branch when it contains data of committed transactions (e.g., a private branch cannot be merged with the master, if it contains data of an uncommitted transaction). There may be different policies used for merging private branches to the master branch. In some examples, as soon as a single transaction commits, the private branch on which the transaction was executed is merged with the master branch. In some examples, multiple transactions may commit in a private branch before that branch is merged to the master. In such examples, the merging occurs in response to one of the following triggers: (1) a timer expires; (2) a resource monitor indicates that a resources usage threshold is met (e.g., available memory is becoming low); and (3) transactions associated with that branch are all committed. Other merge policies may also be implemented depending on the type of a transaction or the specification of a user. Also, merging may be performed in response to an explicit merge request by a client.

A commit creates a clean tree (e.g., tree data structure 210) from a dirty tree, transforming records into files with the tree directory structure. A merge applies a private branch to a master branch, creating a new version of the master branch. A flush persists a commit, making it durable, by writing data to persisted physical storage. Typically, master branches are flushed, although in some examples, private branches may also be flushed (in some scenarios). An example order of events is: commit, merge, flush the master branch (the private branch is now superfluous), then update a crash recovery log cursor position. However, if a transaction is large, and exceeds available memory, a private branch may be flushed. This may be minimized to only occur when necessary, in order to reduce write operations.

FIG. 2B shows an example in which a master branch 200 passes through three versions, with a snapshot created for each version. The active master branch 200 is also mutable, as private branches are merged into the current master branch. Merging involves incorporating new nodes and data from a private branch into the master branch, replacing equivalent nodes (having old contents), adding new nodes, and/or deleting existing nodes. However, there are multiple snapshots of master branch 200 through which the evolution of the data over time may be tracked. Read operations that are not part of a transaction may be served from a snapshot of the master branch. Typically, reads are served from the most recent master branch snapshot, unless the read is targeting an earlier version of the data (e.g., time travel). A table may comprise multiple files that are formatted for storing a set of tuples, depending on the partitioning scheme and lifetime of a private branch. In some examples, a new file is created when merging a private branch. A read may be serviced using multiple files, depending on the time range on the read query. In some examples, parquet files are used. In some examples, a different file format is used, such as optimized row columnar (ORC), or Avro.

Master branch snapshot 252a is created for master branch 200, followed by a master branch snapshot 252b, which is then followed by a master branch snapshot 252c. Master branch snapshots 252a-252c reflect the content of master branch 200 at various times, in a linked list 250, and are read-only. Linked list 250 provides tracking data lineage, for example, for data policy compliance. In some examples, a data structure other than a linked list may be used to capture the history and dependencies of branch snapshots. In some examples, mutable copies of a branch snapshot may be created that can be used for both reads and writes. Some examples store an index of the linked list in a separate database or table in memory to facilitate rapid queries on time range, modified files, changes in content, and other search criteria.

FIG. 3A illustrates data partitioning structure 300, which is captured by the hierarchical namespace of the overlay file system (e.g., version control interface 110). Partitioning is a prescriptive scheme for organizing tabular data in a data lake file system. Thus, data partitioning structure 300 has a hierarchical arrangement 310 with a root level folder 301 and a first tier with folders identified by a data category, such as a category_A folder 311, a category_B folder 312, and a category_C folder 313. Category_B folder 312 is shown with a second tier indicating a time resolution of years, such as a year-2019 folder 321, a year-2520 folder 322, and a year-2521 folder 323. Year-2520 folder 322 is shown with a third tier indicating a time resolution of months, such as a January (Jan) folder 331 and a February (Feb) folder 332. Feb folder 332 is shown as having data object 121 and data object 122. In some examples, pointers to data objects are stored in the contents of directory nodes.

The names of the folders leading to a particular object are path components of a path to the object. For example, stringing together a path component 302a (the name of root level folder 301), a path component 302b (the name of category_B folder 312), a path component 302c (the name of year-2520 folder 322), and a path component 302d (the name of Feb folder 332), gives a path 302 pointing to data object 121.

A table is a collection of files (e.g., a naming convention that indicates a set of files at a specific point in time), and a set of directories in a storage system. In some examples, tables are structured using a primary partitioning scheme, such as time (e.g., date, hour, minutes), and directories are organized according to the partitioning scheme. In an example of using a timestamp for partitioning, an interval is selected, and incoming data is timestamped. At the completion of the interval, all data coming in during the interval is collected into a common file. Other organization, such as data source, data user, recipient, or another, may also be used, in some examples. This permits rapid searching for data items by search parameters that are reflected in the directory structure.

Tables may be organized by rows or columns. FIG. 3B illustrates examples of columnar versions of tables 161 and 164. Table 161 is illustrated as identifying data object 121 and data object 122, and table 164 is illustrated as identifying data object 127 and data object 128, all of which are also shown in FIG. 1.

FIG. 4 illustrates architecture 400 that advantageously provides transaction-aware table placement. Architecture 400 has a front end 410 and separate compute tier 420 (back end) and storage tier 430. A client 402 generates a request 404 through a query engine 406, which may be writer 134 (or another entity) to version control interface 110 for accessing data in data lake 120. In some examples, request 404 goes to front end 410 first, which sends request 404 to compute tier 420.

Examples of the disclosure may be storage agnostic, and use an external service for actual storage. However, for the purposes of illustrating how data is not required to move when operational control of a table moves, a specific storage scheme is illustrated. Data objects are stored in storage tier 430 in a set of hosts 435 (each host a separate compute node), which includes hosts 431-434. Data objects 121 and 123 reside on host 431, data objects 122 and 125 reside on host 432, data objects 124 and 127 reside on host 433, and data objects 126 and 128 reside on host 434. It should be understood that the number of hosts and the placement of two data objects on each host is merely illustrative, and a larger number of hosts may be used, along with a larger number of data objects per host. Data lake 120 of architecture 100 may be comprised of one or more storage tiers 430.

In FIG. 4, table 161 is illustrated as being owned by a host 421 and table 164 is initially owned by a host 422 (but is also shown as being moved, for operational control, to host 421). Meanwhile, data object 121 resides on a host 431, data object 122 resides on a host 432, data object 127 resides on a host 433, and data object 128 resides on a host 434. Because tables and the data objects they identify are stored separately, operational control of a table (e.g., table 164) is moved from one host to another without moving the actual data objects that are used to constitute the tables (e.g., the data objects identified by the table). Therefore, moving operational control of table 164 from host 422 to host 421 does not affect the location of data objects 127 and 128.

Access to data objects is managed by compute tier 420, which has a set of hosts 425 (each host a separate compute node), including hosts 421 and 422, that hold plurality of tables 167 (see FIG. 1). Host 421 has ownership of tables 161-163 (initially), and an implementation of version control interface 110. Host 422 has ownership of tables 164-166 (initially), and an implementation of version control interface 110. As described herein, operational control of table 164 will be moved from host 422 to host 421, even as neither data object 127 nor data object 128 moves. Performing this move of operational control of table 164 minimizes future cross host transactions, such as reducing the number of 2PC processes and increasing the number of single-host transactions, thereby improving the speed of accessing data objects in storage tier 430 (and thus in data lake 120).

For read-only operations, query engine 406 may identify relevant data objects in metadata store 160 and then just pull the data from storage tier using version control interface 110. Ins some examples, read operations also go through front-end 410, which pulls the data from storage tier 430. No commits are needed for read-only operations. However, for write operations, transactions are more involved, as next described.

For a write operation, a load balancer 408 selects a front-end server, such as server 411 or server 412 in front end 410. The write operation will need to access one or more tables of tables 161-166. A directory service 440 stores a routing map 442 that identifies which back-end server (i.e., which of hosts 421 and 422) owns the tables involved in the transaction. In some examples, directory service 440 may be ETCD, and may be the same entity as key-value store 150. In some examples, servers 411 and 412 cache local copies of routing map 442 as routing map 442a and routing map 442b, respectively. When servers detect that their local routing map copies are stale, they will retrieve a fresh copy of routing map 442 from directory service 440.

Writes are journaled in WAL 138 as messages, either directly by a front-end server, or via a back end server. For example, the front-end server sends the write message to the back end server, which sends it to WAL 138 to wait its turn. Since WAL 138 is first in first out (FIFO), in some examples, writes are held in WAL 138 until the proper host (e.g., host 421 or 422) that owns proper table has acknowledged that the write operation is complete. For example, write operations affecting table 161 are sent to host 421 and write operations affecting table 165 are sent to host 422. As described above, version control interface, implemented on either host 421 or 422, consults metadata store 160 for the specific locations of affected data objects.

When transactions involve tables on both host 421 and 422, cross-host coordination, such as 2PC is needed to ensure ACID properties upon commits. This is more time and power-consuming than single-host transactions that do not require cross-host coordination. Thus, if transactions are relatively common that write to both table 161 and table 164, either operational control of table 164 should be moved to host 421, or else operational control of table 161 should be moved to host 422.

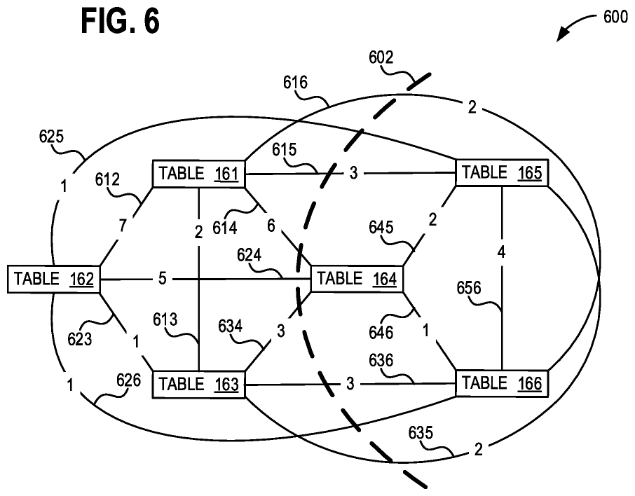

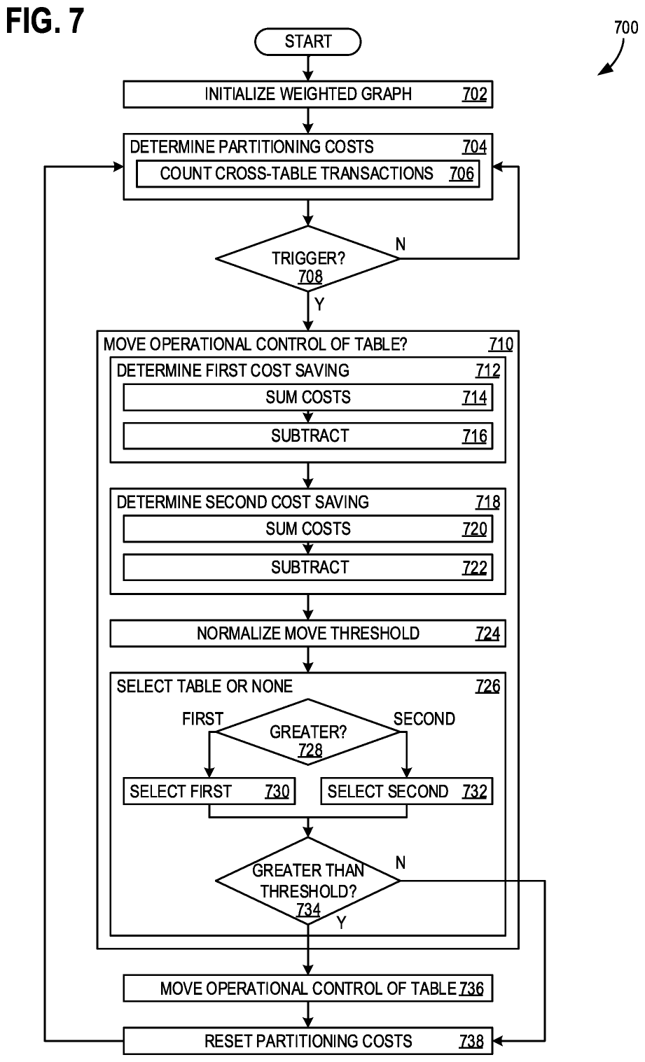

Optimizer 450 performs transaction-aware table placement and is illustrated as being located in front end 410, but may be located elsewhere, in some examples. Examples of optimizer 450 operate according to flowchart 700 of FIG. 7. In the specific example illustrated, if the cost of interaction between table 164 and 161 is above the configured threshold, optimizer 450 decides whether to: (1) move operational control of table 164 to host 421, (1) move operational control of table 161 to host 422, or (3) not move operational control of either of the two tables. Optimizer 450 is shown as storing a transaction history 452, that includes information on cross-table transactions, a weighted graph 600, which is described in further detail in relation to FIG. 6, a move threshold 454, and a repartitioning threshold 456.

Architecture 400 efficiently scales transactions across nodes keeping overhead, required for consistency, to a minimum. In a SQL workload, a schema (e.g., a table group) represents the outline of tables and how tables are related to one another. A table contains various partitions, and partitions may contain multiple data files (e.g., in a Parquet or ORC format). A primary partitioning scheme may be derived from any table column. Typically, primary partitioning is date-time, although other partitioning schemes may be used. In architecture 400, placement granularity is tables, although the same principles may be applied to another granularity level. Placement refers to ownership of a table (e.g., which back end server has read/write access on the table), which differ from physical storage location. In some examples, tables are physically stored in a shared object store (e.g., metadata store), and hosts 421 and 422 merely have ownership rights (e.g., read/write access rights) for specific tables.

A table may be owned by only a single host, the reference herein to moving operational control of a table among hosts means moving ownership rights or control of performing operations or computations for the table, even if the actual physical storage location of data in that table does not change. Table groups, however, may span multiple hosts. Because architecture 400 supports multi-table transactions, the consistency boundary may span from being within a single host, to spanning a few hosts, to spanning an entire cluster of hosts.

A transaction is started at front end 410, in which one of servers 411 and 412 (e.g., front end servers) acts as a routing node. The specific sever may be determined by load balancer 408. Back end servers (e.g., hosts 421 and 422) consume WAL 138 and act as the data path. When a transaction is started by client 402 for any table group, a routing node will inform all the backend nodes where the table group is partitioned. This information allows backend nodes to keep track of all the ongoing transactions and impose a resource quota. As and when the writes for the transaction come in, the routing node will send the writes to the backend node that owns the table.

Because a transaction may span across various tables, different writes in the transaction may end up on different back-end servers (such as host 421 and 422). When the transaction is committed, the routing node will decide whether the commit requires cross-host coordination, such as a 2PC. If all the writes of the transaction are for the tables owned by a single host, cross-host coordination will be avoided. Otherwise, the routing node will orchestrate the cross-host coordination among the participating backend nodes. Once the transaction is committed, the hash of the snapshot will be updated in key-value store 150. WAL 138 is then checkpointed to reflect a new crash recovery point after the transaction.

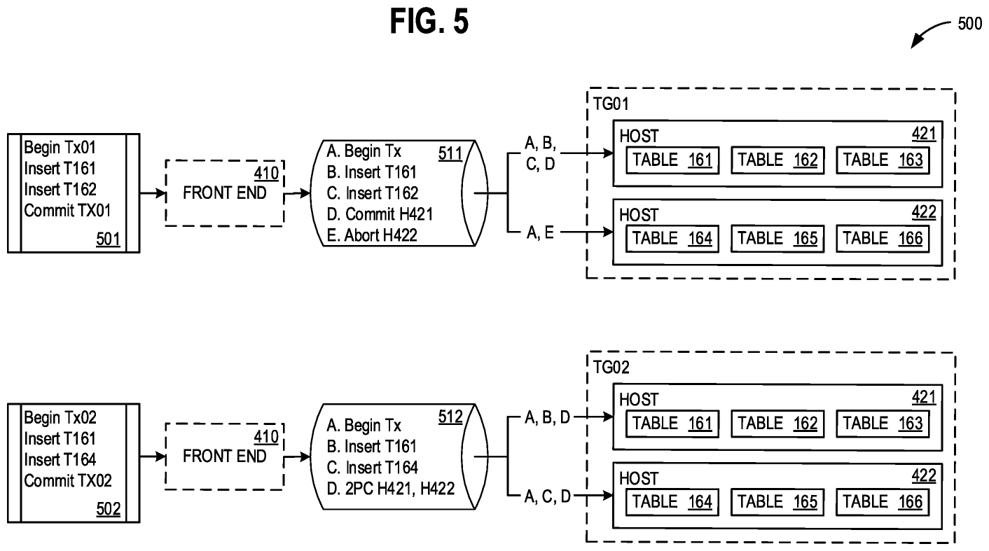

FIG. 5 illustrates an example workflow 500 that may be implemented when using architecture 400. A transaction 501 (self-labeled as Tx01) is on a first table group TG01. A routing node, one of servers 411 and 412 in front end 410, signals hosts 421 and 422 with commands 511. Commands “Begin Tx”, “Insert T161”, “Insert T162”, and “Commit H421” are sent to host 421 (where H421 refers to host 421). Commands “Begin Tx” and “Abort H422” are sent to host 422 (where H422 refers to host 422). Host 421 performs a quicker local commit because no 2PC is needed.

For comparison, a transaction 502 (self-labeled as Tx02) is also shown but which requires 2PC. Transaction 502 is on a second table group TG02. A routing node, one of servers 411 and 412 in front end 410, signals hosts 421 and 422 with commands 512. Commands “Begin Tx”, “Insert T161”, and “2PC H421, H422” are sent to host 421. Commands “Begin Tx”, “Insert T164”, and “2PC H421, H422” are sent to host 422.

Workflow 500 may encounter a crash anytime. Architecture 400 is able to recover from a crash, because the transaction operations are journaled in WAL 138, including the 2PC orchestration. If a crash occurs any time prior to updating routing map 442 in directory service 440 (or key-value store 150), the back-end nodes read the most recently-committed hash and replay the messages from WAL 138 after the latest checkpoint.

Because multiple writers (e.g., writers 134 and 136 of FIG. 1) may have transactions on the same tables at the same time, the commit operation might encounter a conflict. In the event of a conflict, the routing node will be informed by the backend node that encounters it. The routing node will abort the transaction on all the participating backend nodes. If any backend node has already committed the transaction, the node will roll back to the last committed snapshot to undo the changes of the transaction.

For initial load balancing, tables are placed on different hosts depending on the capacity of the hosts. The initial placement, however, may not be ideal for minimizing cross-host transactions. With dynamic placement, based on transaction history, transaction-aware table placement redistributes the tables (e.g., redistributes ownership of the tables) to minimize cross-host transactions. This improves the overall latency for committing transactions, thereby increasing system throughput. Thus, during initial distribution, spare capacity is left at each of hosts 421 and 422 to allow for the importation of tables. In some examples, this amount of space is 3% minimum, determined empirically from historical experience.

To determine which tables should have operational control moved, and to where, some examples of architecture 400 generate a version of weighted graph 600, as shown in FIG. 6. In weighted graph 600, each table represents a node of the graph, and edges between the nodes are weighted by the count of historical interactions of having tables, on each end of the edge, on different nodes. In weighted graph 600, the nodes are tables 161-166, and the heavy dashed line represents a cross-host boundary 602. Tables 161-163 on one side of boundary 602 are on one host (host 421), and tables 164-166 on the other side of boundary 602 are on a different host (host 422). An edge's weight represents historical data about the number of transactions that include the two tables that correspond to the nodes the edge interconnects. This information is used to determine costs and cost optimizations of partitioning.

Edge 612, between tables 161 and 162 has a value of 7. This means that there have been seven transactions that involved both tables 161 and 162. In some examples, the count of historical interactions is set by simply counting the number of transactions involving both tables. In such examples, each transaction is weighted the same. In some examples, the counts may be weighted. In some examples, weighted graph 600 is reset or normalized on a trigger, such as a lapse of a timer or reaching a configured number of operations. Then upon another trigger event, such as a timer event, or one of the counts reaching repartitioning threshold 456, optimizer 450 examines weighted graph 600 and selects a table for which operational control should be moved (or not), and resets or normalizes the edge values.

Edge 613, between tables 161 and 163 has a value of 2; edge 614, between tables 161 and 164 has a value of 6; edge 615, between tables 161 and 165 has a value of 3; and edge 616, between tables 161 and 166 has a value of 2. Edge 623, between tables 162 and 163 has a value of 1; edge 624, between tables 162 and 164 has a value of 5; edge 625, between tables 162 and 165 has a value of 1; and edge 626, between tables 162 and 166 has a value of 1. Edge 634, between tables 163 and 164 has a value of 3; edge 635, between tables 163 and 165 has a value of 2; and edge 636, between tables 163 and 166 has a value of 3. Edge 645, between tables 164 and 165 has a value of 2; edge 646, between tables 164 and 166 has a value of 1; and edge 656, between tables 165 and 166 has a value of 4.

Counts of historical interactions between tables that are already collocated on the same host are not used for the purposes of determining cost savings of moving operational control of tables to be collocated but are used for calculating a cost savings when moving operational control of one of two already collocated tables to a different host. Edges that span boundary 602, however, count toward determining cost savings of moving operational control of one of the tables to be collocated with the other. Initially, with table 164 on host 422, the edges that span boundary 602 are edges 614, 615, 616, 624, 625, 626, 634, 635, and 636. Of these edges, the edge having the highest value is edge 614, with a value of 6.

One repartitioning algorithm is given by the following: Identify an edge spanning a cross-host boundary that has the maximal value. Denote the edge Tᵢ:Hₖ-Tⱼ:Hₘ, where Tᵢ:Hₖ means that table i is on host k. This represents the interaction of Tᵢ on Hₖ with Tⱼ on Hₘ. Two moves are possible for each edge. Either move operational control of Tᵢ to Hₘ, or move operational control of Tⱼ to Hₖ. Calculate the savings of moving operational control of each table by adding the weights of the edges that will become free and subtracting the weights that will no longer be free after the move.

Contemplating moving operational control of Tᵢ to Hₘ, all the interactions of Tᵢ on Hₘ will become free and all the interactions of Tᵢ on Hₖ will become penalties (no longer free). If the larger resulting sum (which represents a cost savings of performing the move) is greater than move threshold 454, operational control of the table is moved (e.g., the table ownership is moved). Move threshold 454 is tied to a minimal benefit that is obtained by moving operational control of a table from one host to another, in order to reduce cross-host transactions. In some examples, the move threshold 454 is normalized after every run through the repartitioning algorithm, because the edge weights are cumulative. In some examples, only up to one move per iteration of the repartitioning algorithm is permitted, to keep the algorithm time bounded and also to avoid thrashing.

Using the example values shown in FIG. 6, the cost savings of moving operational control of table 161 from host 421 to host 422 may be compared with the cost savings of moving operational control of table 164 from host 422 to host 421. Edge 614, with a value of 6, has the highest value of all edges spanning boundary 602.

Another example contemplates moving operational control of table 161 from host 421 to host 422: Sum the newly free counts of edge 614 (6), edge 615 (3), and edge 616 (2). 6+3+2=11. Add the counts that will no longer be free and subtract this amount. These are edges 612 (7) and edge 613 (2), which totals 9. Subtracting yields 11−9=2. Thus, the potential cost savings by moving operational control of table 161 from host 421 to host 422 has a value of 2.

Another example contemplates moving operational control of table 164 from host 422 to host 421: Sum the newly free counts of edge 614 (6), edge 624 (5), and edge 634 (3). 6+5+3=14. Add the counts that will no longer be free and subtract this amount. These are edges 645 (2) and edge 646 (1), which totals 3. Subtracting yields 14−3=11. Thus, the potential cost savings by moving operational control of table 164 from host 422 to host 421 has a value of 11.

If move threshold 454 has a value of 10, operational control of table 164 will be moved from host 422 to host 421. However, if move threshold 454 has a value of 12, operational control of table 164 will not be moved.

FIG. 7 illustrates a flowchart 700 of exemplary operations associated with architecture 400. In some examples, the operations of flowchart 700 are performed by one or more computing apparatus 900 of FIG. 9. Flowchart 700 commences with operation 702, which generates an initial table placement and initializes weighted graph 600 or recovers weighted graph 600 from a previous cycle through flowchart 700. Each node of weighted graph 600 represents a table of plurality of tables 167, and each edge of weighted graph 600 represents the count of historical interactions between the tables represented by the connected nodes of the edge. Table 164 and table 161 are each owned by a host in compute tier 420 comprising set of hosts 425. Table 164 identifies at least data object 127 and table 161 identifies at least data object 121. Data object 121 and data object 127 each resides in storage tier 430 comprising set of hosts 435. Set of hosts 425 and set of hosts 435 do not overlap.

Operation 704 determines counts of historical interactions between tables of plurality of tables 167, based on at least a transaction history for a plurality of cross-table transactions. Operation 704 is performed using operation 706, which includes, for each cross-table transaction involving both table 164 and table 161, increasing the count of historical interactions between table 164 and table 161. In some examples, determining the count of historical interactions between table 164 and table 161 comprises determining a count of cross-table transactions involving both table 164 and table 161, such as by incrementing the count of historical interactions.

Decision operation 708 determines whether a repartitioning trigger condition has been encountered. In some examples, the trigger condition comprises a timer event. In some examples, the trigger condition comprises a count of historical interactions reaching repartitioning threshold 456. In some examples, the count of historical interactions that is measured against repartitioning threshold 456 comprises a count between tables on different hosts (e.g., counts between tables on a common host are not used to trigger repartitioning). In the example used to further describe flowchart 700, the count of historical interactions between table 164 and table 161 is the highest count of historical interactions between tables on different hosts.

If no trigger condition has been encountered, flowchart returns to operation 704. Otherwise, operation 710 determines whether to move operational control of a table, and which table should be selected, using operations 712-734. In some examples, moving operational control of a table from one host to another host comprises moving ownership of the table instead of moving the physical location of the data constituting the table. In other examples, moving operational control of the table also includes moving the physical location of the data constituting table.

Operation 712, performed using operations 714 and 716, determines a first cost savings of moving operational control of table 164 from host 422 to host 421. Operation 714 sums counts between table 164 and all tables on host 421. Operation 716 subtracts, from the sum of operation 714, counts between table 164 and all tables on host 422 (which will no longer be free if operational control of table 164 is moved). Operation 718, performed using operations 720 and 722, determines a second cost savings of moving operational control of table 161 from host 421 to host 422. Operation 720 sums counts between table 161 and all tables on host 422. Operation 722 subtracts, from the sum of operation 720, counts between table 161 and all tables on host 421 (which will no longer be free if operational control of table 161 is moved).

Operation 724 normalizes move threshold 454. On the subsequent pass through flowchart 700, operation 724 includes (generally): upon moving operational control of either table 164 or table 161, normalize move threshold 454. However, in this specific example, operation 724 is: based on at least moving operational control of table 164, normalize move threshold 454.

Operation 726 determines whether to move operational control of table 164, move operational control of table 161, or to not move operational control of either table 164 or table 161, as performed using operations 728-734. Decision operation 728 selects a move candidate by determining which provides the better potential transactional cost savings by minimizing cross-host table interactions. If it is the first table (e.g., table 164), operation 730 selects table 164. If it is the second table (e.g., table 161), operation 732 selects table 161. In this specific example, however, the result is: based on at least the first cost savings exceeding the second cost savings, determining to move operational control of table 164 from host 422 to host 421 and to not move operational control of table 161 from host 421 to host 422.

In some examples, determining to move operational control of table 164 comprises determining that the first cost savings exceeds move threshold 454. In such examples, decision operation 734 determines whether the potential cost savings exceeds move threshold 454. In some examples, move threshold 454 is based on at least a cross-host transaction coordination, and in some examples, Is determined empirically. In some examples, that cross-host transaction coordination comprises a 2PC.

Operation 736 moves operational control of the selected table. In general, this is: based on at least the first cost savings and the second cost savings, either moving operational control of table 164 from host 422 to host 421, or moving operational control of table 161 from host 421 to host 422. Moving operational control of table 164 and moving operational control of table 161 are each performed without moving data object 127 identified by table 164 and also without moving data object 121 identified by table 161. In some examples, moving operational control of table 164 from host 422 to host 421 comprises moving ownership of table 164 from host 422 to host 421. Prior to moving operational control of table 164, table 164 is owned by host 422 and table 161 is owned by host 421. After moving operational control of table 164, table 164 and table 161 are both owned by host 421.

Upon moving operational control of either table 164 or table 161 (in this example, it is: based on at least moving operational control of table 164), operation 738 normalizes the counts in weighted graph 600 (or normalizes move threshold 454, which is equivalent). If no table is selected for moving in operation 710, however, flowchart 700 bypasses operation 736 and goes directly to operation 738. Flowchart 700 then returns to operation 704 to start the next cycle of optimization of transaction-aware table placement.

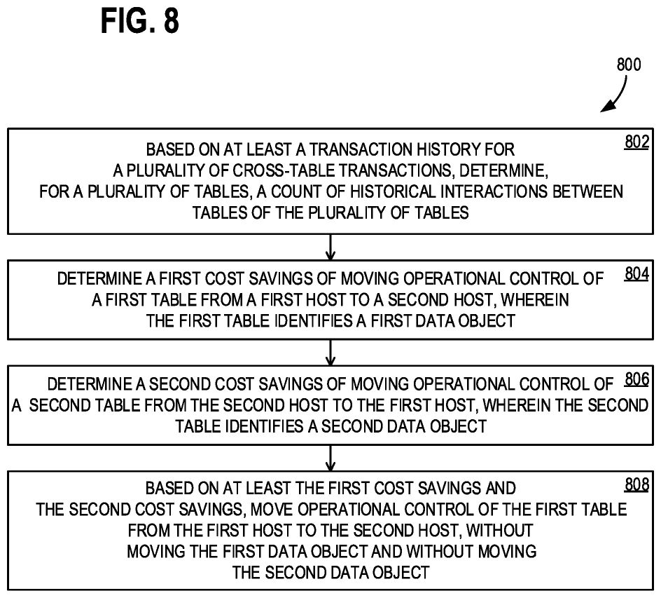

FIG. 8 illustrates a flowchart 800 of exemplary operations that are associated with architecture 100. In some examples, the operations of flowchart 800 are performed by one or more computing apparatus 900 of FIG. 9. Flowchart 800 commences with operation 802, which includes, based on at least a transaction history for a plurality of cross-table transactions, determining, for a plurality of tables, a count of historical interactions between tables of the plurality of tables. Operation 804 includes determining a first cost savings of moving operational control of a first table from a first host to a second host, wherein the first table identifies a first data object. Operation 806 includes determining a second cost savings of moving operational control of a second table from the second host to the first host, wherein the second table identifies a second data object. Operation 808 includes, based on at least comparing the first cost savings and the second cost savings, moving operational control of the first table from the first host to the second host, without moving the first data object and without moving the second data object.

### Additional Examples

An example method comprises: based on at least a transaction history for a plurality of cross-table transactions, determining, for a plurality of tables, a count of historical interactions between tables of the plurality of tables; determining a first cost savings of moving operational control of a first table from a first host to a second host, wherein the first table identifies a first data object; determining a second cost savings of moving operational control of a second table from the second host to the first host, wherein the second table identifies a second data object; and based on at least the first cost savings and the second cost savings, moving operational control of the first table from the first host to the second host, without moving the first data object and without moving the second data object.

An example computer system comprises: a processor; and a non-transitory computer readable medium having stored thereon program code executable by the processor, the program code causing the processor to: based on at least a transaction history for a plurality of cross-table transactions, determine, for a plurality of tables, a count of historical interactions between tables of the plurality of tables; determine a first cost savings of moving operational control of a first table from a first host to a second host, wherein the first table identifies a first data object; determine a second cost savings of moving operational control of a second table from the second host to the first host, wherein the second table identifies a second data object; and based on at least the first cost savings and the second cost savings, move operational control of the first table from the first host to the second host, without moving the first data object and without moving the second data object.

An example non-transitory computer storage medium has stored thereon program code executable by a processor, the program code embodying a method comprising: based on at least a transaction history for a plurality of cross-table transactions, determining, for a plurality of tables, a count of historical interactions between tables of the plurality of tables; determining a first cost savings of moving operational control of a first table from a first host to a second host, wherein the first table identifies a first data object; determining a second cost savings of moving operational control of a second table from the second host to the first host, wherein the second table identifies a second data object; and based on at least the first cost savings and the second cost savings, moving operational control of the first table from the first host to the second host, without moving the first data object and without moving the second data object.

Alternatively, or in addition to the other examples described herein, examples include any combination of the following:
the first table and the second table are each owned by a host in a compute tier comprising a first set of hosts;
the first data object and the second data object each resides in a storage tier comprising a second set of hosts;
moving operational control of the first table from the first host to the second host comprises moving ownership of the first table;
the first set of hosts and the second set of hosts do not overlap;
generating a weighted graph;
each node of the weighted graph represents a table of the plurality of tables;
each edge of the weighted graph represents the count of historical interactions between the tables represented by connected nodes of the edge;
determining the count of historical interactions between the first table and the second table comprises determining a count of cross-table transactions involving both the first table and the second table;
based on at least a trigger condition, determining whether to move operational control of a table;
the trigger condition comprises a timer event;
the trigger condition comprises a count of historical interactions reaching a repartitioning threshold;
the count of historical interactions measured against the repartitioning threshold comprises a count of historical interactions between tables on different hosts;
the count of historical interactions between the first table and the second table is the highest count of historical interactions between tables on different hosts;
determining the first cost savings comprises summing counts of historical interactions between the first table and tables on the second host;
determining the first cost savings further comprises subtracting, from the sum, counts of historical interactions between the first table and tables on the first host;
determining the second cost savings comprises summing counts of historical interactions between the second table and tables on the first host and subtracting, from the sum, counts of historical interactions between the second table and tables on the second host;
based on at least the first cost savings exceeding the second cost savings, determining to move operational control of the first table from the first host to the second host and to not move operational control of the second table from the second host to the first host;
determining to move operational control of the first table comprises determining that the first cost savings exceeds a move threshold;
the cross-host transaction coordination comprises a two-phase commit (2PC);
based on at least the first cost savings and the second cost savings, either moving operational control of the first table from the first host to the second host or moving operational control of the second table from the second host to the first host;
moving operational control of the first table and moving operational control of the second table are each performed without moving a data object identified by the first table and also without moving a data object identified by the second table;
upon moving operational control of either the first table or the second table, resetting the counts of historical interactions;
based on at least moving operational control of the first table, normalizing the counts of historical interactions;
based on at least moving operational control of the first table, normalizing the move threshold;
upon moving operational control of either the first table or the second table, normalizing the move threshold;
prior to moving operational control of the first table, the first table is owned by the first host and the second table is owned by the second host; and
after moving operational control of the first table, the first table and the second table are both owned by the second host.

### Exemplary Operating Environment

The present disclosure is operable with a computing device (computing apparatus) according to an embodiment shown as a functional block diagram in FIG. 9. In an embodiment, components of a computing apparatus 900 may be implemented as part of an electronic device according to one or more embodiments described in this specification. The computing apparatus 900 comprises one or more processors 919 which may be microprocessors, controllers, or any other suitable type of processors for processing computer executable instructions to control the operation of the electronic device. Alternatively, or in addition, the processor 919 is any technology capable of executing logic or instructions, such as a hardcoded machine. Platform software comprising an operating system 920 or any other suitable platform software may be provided on the computing apparatus 900 to enable application software 921 to be executed on the device. According to an embodiment, the operations described herein may be accomplished by software, hardware, and/or firmware.

Computer executable instructions may be provided using any computer-readable medium (e.g., any non-transitory computer storage medium) or media that are accessible by the computing apparatus 900. Computer-readable media may include, for example, computer storage media such as a memory 922 and communications media. Computer storage media, such as a memory 922, include volatile and non-volatile, removable, and non-removable media implemented in any method or technology for storage of information such as computer readable instructions, data structures, program modules or the like. In some examples, computer storage media are implemented in hardware. Computer storage media include, but are not limited to, RAM, ROM, EPROM, EEPROM, persistent memory, non-volatile memory, phase change memory, flash memory or other memory technology, compact disc (CD, CD-ROM), digital versatile disks (DVD) or other optical storage, floppy drives, hard disks, magnetic cassettes, magnetic tape, magnetic disk storage, shingled disk storage or other magnetic storage devices, or any other non-transmission medium that can be used to store information for access by a computing apparatus. Computer storage media are tangible, non-transitory, and are mutually exclusive to communication media.

In contrast, communication media may embody computer readable instructions, data structures, program modules, or the like in a modulated data signal, such as a carrier wave, or other transport mechanism. As defined herein, computer storage media do not include communication media. Therefore, a computer storage medium should not be interpreted to be a propagating signal per se. Propagated signals per se are not examples of computer storage media. Although the computer storage medium (memory 922) is shown within the computing apparatus 900, it will be appreciated by a person skilled in the art, that the storage may be distributed or located remotely and accessed via a network or other communication link (e.g., using a communication interface 923).

The computing apparatus 900 may comprise an input/output controller 924 configured to output information to one or more output devices 925, for example a display or a speaker, which may be separate from or integral to the electronic device. The input/output controller 924 may also be configured to receive and process an input from one or more input devices 926, for example, a keyboard, a microphone, or a touchpad. In one embodiment, the output device 925 may also act as the input device. An example of such a device may be a touch sensitive display. The input/output controller 924 may also output data to devices other than the output device, e.g., a locally connected printing device. In some embodiments, a user may provide input to the input device(s) 926 and/or receive output from the output device(s) 925.

The functionality described herein can be performed, at least in part, by one or more hardware logic components. According to an embodiment, the computing apparatus 900 is configured by the program code when executed by the processor 919 to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Program-specific Standard Products (ASSPs), System-on-a-chip systems (SOCs), Complex Programmable Logic Devices (CPLDs), Graphics Processing Units (GPUs).

Although described in connection with an exemplary computing system environment, examples of the disclosure are operative with numerous other general purpose or special purpose computing system environments or configurations. Examples of well-known computing systems, environments, and/or configurations that may be suitable for use with aspects of the disclosure include, but are not limited to, mobile computing devices, personal computers, server computers, hand-held or laptop devices, multiprocessor systems, gaming consoles, microprocessor-based systems, set top boxes, programmable consumer electronics, mobile telephones, network PCs, minicomputers, mainframe computers, distributed computing environments that include any of the above systems or devices.

Examples of the disclosure may be described in the general context of computer-executable instructions, such as program modules, executed by one or more computers or other devices. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions or the specific components or modules illustrated in the figures and described herein. Other examples of the disclosure may include different computer-executable instructions or components having more or less functionality than illustrated and described herein.

Aspects of the disclosure transform a general-purpose computer into a special purpose computing device when programmed to execute the instructions described herein. The detailed description provided above in connection with the appended drawings is intended as a description of a number of embodiments and is not intended to represent the only forms in which the embodiments may be constructed, implemented, or utilized.

The term “computing device” and the like are used herein to refer to any device with processing capability such that it can execute instructions. Those skilled in the art will realize that such processing capabilities are incorporated into many different devices and therefore the terms “computer”, “server”, and “computing device” each may include PCs, servers, laptop computers, mobile telephones (including smart phones), tablet computers, and many other devices. Any range or device value given herein may be extended or altered without losing the effect sought, as will be apparent to the skilled person. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

While no personally identifiable information is tracked by aspects of the disclosure, examples may have been described with reference to data monitored and/or collected from the users. In some examples, notice may be provided to the users of the collection of the data (e.g., via a dialog box or preference setting) and users are given the opportunity to give or deny consent for the monitoring and/or collection. The consent may take the form of opt-in consent or opt-out consent.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure. It will be understood that the benefits and advantages described above may relate to one embodiment or may relate to several embodiments. When introducing elements of aspects of the disclosure or the examples thereof, the articles “a,” “an,” and “the” are intended to mean that there are one or more of the elements. The terms “comprising,” “including,” and “having” are intended to be inclusive and mean that there may be additional elements other than the listed elements. The term “exemplary” is intended to mean “an example of.”

Having described aspects of the disclosure in detail, it will be apparent that modifications and variations are possible without departing from the scope of aspects of the disclosure as defined in the appended claims. As various changes may be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A method comprising:
based on at least a transaction history for a plurality of cross-table transactions, determining, for a plurality of tables, a count of historical interactions between tables of the plurality of tables;
determining, based on at least the count of historical interactions, a first cost savings of moving operational control of a first table from a first host to a second host, wherein the first table identifies a first data object;
determining, based on at least the count of historical interactions, a second cost savings of moving operational control of a second table from the second host to the first host, wherein the second table identifies a second data object; and
based on at least a comparison of the first cost savings and the second cost savings, moving operational control of the first table from the first host to the second host, without moving the first data object and without moving the second data object.

2. The method of claim 1, further comprising:
generating a weighted graph, wherein each node of the weighted graph represents a table of the plurality of tables, and wherein each edge of the weighted graph represents the count of historical interactions between the tables represented by connected nodes of the edge.

3. The method of claim 1, further comprising:
based on at least moving operational control of the first table, normalizing the counts of historical interactions.

4. The method of claim 1, further comprising:
based on at least the first cost savings exceeding the second cost savings, determining to move operational control of the first table from the first host to the second host and to not move operational control of the second table from the second host to the first host.

5. The method of claim 4, wherein determining to move operational control of the first table comprises:
determining that the first cost savings exceeds a move threshold.

6. The method of claim 1, wherein determining a count of historical interactions between the first table and the second table comprises:
determining a count of cross-table transactions involving both the first table and the second table.

7. The method of claim 1, wherein determining the first cost savings comprises:
summing counts of historical interactions between the first table and tables on the second host; and
subtracting, from the sum, counts of historical interactions between the first table and tables on the first host.

8. The method of claim 1, wherein the first table and the second table are each owned by a host in a compute tier comprising a first set of hosts, and wherein the first data object and the second data object each resides in a storage tier comprising a second set of hosts.

9. A computer system comprising:
a processor; and
a non-transitory computer readable medium having stored thereon program code executable by the processor, the program code causing the processor to:
based on at least a transaction history for a plurality of cross-table transactions, determine, for a plurality of tables, a count of historical interactions between tables of the plurality of tables;
determine, based on at least the count of historical interactions, a first cost savings of moving operational control of a first table from a first host to a second host, wherein the first table identifies a first data object;
determine, based on at least the count of historical interactions, a second cost savings of moving operational control of a second table from the second host to the first host, wherein the second table identifies a second data object; and
based on at least a comparison of the first cost savings and the second cost savings, move operational control of the first table from the first host to the second host, without moving the first data object and without moving the second data object.

10. The computer system of claim 9, wherein the program code is further operative to:
generate a weighted graph, wherein each node of the weighted graph represents a table of the plurality of tables, and wherein each edge of the weighted graph represents the count of historical interactions between the tables represented by connected nodes of the edge.

11. The computer system of claim 9, wherein the program code is further operative to:
based on at least the first cost savings exceeding the second cost savings, determine to move operational control of the first table from the first host to the second host and to not move operational control of the second table from the second host to the first host.

12. The computer system of claim 9, wherein determining a count of historical interactions between the first table and the second table comprises:
determining a count of cross-table transactions involving both the first table and the second table.

13. The computer system of claim 9, wherein determining the first cost savings comprises:
summing counts of historical interactions between the first table and tables on the second host; and
subtracting, from the sum, counts of historical interactions between the first table and tables on the first host.

14. The computer system of claim 9, wherein the first table and the second table are each owned by a host in a compute tier comprising a first set of hosts, and wherein the first data object and the second data object each resides in a storage tier comprising a second set of hosts.

15. A non-transitory computer storage medium having stored thereon program code executable by a processor, the program code embodying a method comprising:
based on at least a transaction history for a plurality of cross-table transactions, determining, for a plurality of tables, a count of historical interactions between tables of the plurality of tables;
determining, based on at least the count of historical interactions, a first cost savings of moving operational control of a first table from a first host to a second host, wherein the first table identifies a first data object;
determining, based on at least the count of historical interactions, a second cost savings of moving operational control of a second table from the second host to the first host, wherein the second table identifies a second data object; and
based on at least a comparison of the first cost savings and the second cost savings, moving operational control of the first table from the first host to the second host, without moving the first data object and without moving the second data object.

16. The computer storage medium of claim 15, wherein the program code method further comprises:
generating a weighted graph, wherein each node of the weighted graph represents a table of the plurality of tables, and wherein each edge of the weighted graph represents the count of historical interactions between the tables represented by connected nodes of the edge.

17. The computer storage medium of claim 15, wherein the program code method further comprises:
based on at least the first cost savings exceeding the second cost savings, determining to move operational control of the first table from the first host to the second host and to not move operational control of the second table from the second host to the first host.

18. The computer storage medium of claim 15, wherein determining a count of historical interactions between the first table and the second table comprises:
determining a count of cross-table transactions involving both the first table and the second table.

19. The computer storage medium of claim 15, wherein determining the first cost savings comprises:
summing counts of historical interactions between the first table and tables on the second host; and
subtracting, from the sum, counts of historical interactions between the first table and tables on the first host.

20. The computer storage medium of claim 15, wherein the first table and the second table are each owned by a host in a compute tier comprising a first set of hosts, and wherein the first data object and the second data object each resides in a storage tier comprising a second set of hosts.
